(19) United States
(12) Patent Application Publication
(10) Pub. No.: US 2026/0195528 A1
(43) Pub. Date: Jul. 9, 2026

(54) ELECTRONICALLY PARSE COMPLICATED TABLE

(71) Applicant: International Business Machines Corporation, Armonk, NY (US)

(72) Inventors: Dong Rui Li, Beijing (CN); Zai Ming Lao, Beijing (CN); Xue Xu, Beijing (CN); Ye Chen, Beijing (CN); Xue Lan Zhang, Beijing (CN); Wei U Wang, Beijing (CN)

(21) Appl. No.: 19/011,705

(22) Filed: Jan. 7, 2025

(51) Int. Cl. G06F 40/205; G06F 40/177

(52) U.S. Cl. CPC G06F 40/205; G06F 40/177

(57) ABSTRACT

Embodiments of the disclosure relate to electronically parsing a complicated table to extract data. Aspects include electronically parsing an electronic image to identify an irregular table. Aspects include selecting an anchor column in the irregular table, the anchor column comprising column data, where the anchor column is selected based at least in part on coordinates of the column data and on vertical distances of the column data, where rows are determined based on vertical relationships of the vertical distances of the column data of the anchor column. Aspects include separating the rows into snippets in accordance with the vertical relationships of the column data, where row data is extracted from the snippets. Aspects include generating a new data structure such that the row data is combined in the new data structure and causing an action to be performed in response to generating the new data structure.

### BACKGROUND

The present disclosure generally relates to computer systems, and more specifically, to computer-implemented methods, computer systems, and computer program products configured and arranged to electronically parse a complicated table to extract data.

With the advent of technology and ever-increasing data sources, a large amount of complex multidimensional data is generated in many aspects of everyday life. With this surge in data, data visualization has emerged as a technique to extract knowledge from the complex multidimensionality datasets. Data visualization in general refers to visual representation of data in the form of graphs, charts, maps, tables, etc., to provide easily understandable data insights. Data visualization has become a component of any data analysis or data mining process.

A visual static image is generated for an image having a table. The image is divided and optimized according to a pixel requirement and an image processing precision requirement, so as to obtain a table area in the image. This allows an automated system to identify and output the data related to the table area. Because all tables are not formed or formatted the same, there can be unstructured tables which may be borderless or complicated tables. Due to the lack of visible borders, reliable automated detection of a borderless table may be difficult.

### SUMMARY

Embodiments of the disclosure include a computer-implemented method for electronically parsing a complicated table to extract data. The method includes electronically parsing an electronic image to identify an irregular table, where table headers of the irregular table are identified. The method includes selecting an anchor column in the irregular table, the anchor column comprising column data. The anchor column is selected based at least in part on coordinates of the column data and on vertical distances of the column data. Rows are determined based on vertical relationships of the vertical distances of the column data of the anchor column. The method includes separating the rows into snippets in accordance with the vertical relationships of the column data, where row data is extracted from the snippets. The method includes generating a new data structure such that the row data is combined in the new data structure and causing an action to be performed in response to generating the new data structure.

The above features and advantages, and other features and advantages, of the disclosure are readily apparent from the following detailed description when taken in connection with the accompanying drawings.

### BRIEF DESCRIPTION OF THE DRAWINGS

FIG. 1 illustrates a computing environment for executing methods related to electronically parsing and extracting data from unstructured/irregular tables in a digital image in accordance with one or more embodiments.

FIG. 2 illustrates a block diagram of a computer with further details for electronically parsing and extracting data from an unstructured/irregular table in a digital image in accordance with one or more embodiments.

FIG. 3 illustrates a flow diagram for electronically parsing a complicated table to extract data, to generate a new data structure for storing and displaying the extracted data, and to perform one or more actions using the extracted data in accordance with one or more embodiments.

FIG. 4 illustrates an example complicated/irregular table in accordance with one or more embodiments.

FIG. 5 illustrates examples of candidate anchor columns in a complicated/irregular table in accordance with one or more embodiments.

FIG. 6 illustrates an example complicated/irregular table in accordance with one or more embodiments.

FIG. 7A illustrates an example of selecting/determining anchor columns in unstructured data of an irregular table in accordance with one or more embodiments.

FIG. 7B illustrates example pseudocode for determining column data in accordance with one or more embodiments.

FIG. 7C illustrates example pseudocode for calculating the variance of the vertical distances of column data on an anchor column to select the anchor column in accordance with one or more embodiments.

FIG. 8A illustrates examples of candidate anchor columns in the complicated/irregular table in accordance with one or more embodiments.

FIG. 8B illustrates example pseudocode for determining anchor words of column data in an anchor column in accordance with one or more embodiments.

FIG. 8C illustrates example pseudocode for selecting an anchor column having the most anchor words from candidate anchor columns in accordance with one or more embodiments.

FIG. 9A illustrates an example irregular table where a given row is being processed to find the top of each line within the that row such that the spacing can be increased between the lines in that row and the neighboring row in accordance with one or more embodiments.

FIG. 9B illustrates pseudocode for processing lines in each row to increase the spacing between neighboring rows in accordance with one or more embodiments.

FIG. 9C illustrates an example irregular table after increasing/enlarging the line spacings of the rows and spacing between neighboring rows in accordance with one or more embodiments.

FIG. 10A illustrates an example snippet that is based on identifying the tops of neighboring rows in the selected anchor column in accordance with one or more embodiments.

FIG. 10B illustrates an example that uses a middle position of a row in accordance with one or more embodiments.

FIG. 10C illustrates an example irregular table with multiple snippets from which row data is extracted in accordance with one or more embodiments.

FIG. 11 illustrates an example of extracting row data from snippets in accordance with one or more embodiments.

FIG. 12 illustrates an example of extracting row data from snippets using a machine learning model in accordance with one or more embodiments.

FIG. 13 illustrates a flowchart of a computer-implemented method for electronically parsing a complicated table to extract data, generating a new data structure for which to store and display the extracted data, and performing one or more actions using the extracted data in accordance with one or more embodiments.

The above features and advantages, and other features and advantages, of the disclosure are readily apparent from the following detailed description when taken in connection with the accompanying drawings.

### DETAILED DESCRIPTION

One or more embodiments are configured and arranged for electronically parsing a complicated table to extract data and transform the extracted data into a different format than the complicated table such that the extracted data is utilized in subsequent processes.

There are existing applications that can extract data from a table on an image when the rows and columns are arranged in a regular table having a consistent format or spacing for rows and columns. However, extracting data from a complicated table, which is an irregular table, on an image is challenging. Applications cannot parse the irregular table structures well because the rows and columns are mixed up. Characteristics of irregular tables or complicated tables may include any of the following: borderless, multi-line rows, span columns, and/or intensive. A borderless table does not have borders with lines that delineate the rows and/or columns of the table. A table with multi-line rows refers to a row that includes multiple lines in that row. For example, a regular table has a row with one line such that row one denotes line one, row two denotes line two, and so forth. However, a table with multi-line rows has a row with multiple lines in it, and the row data in the multiple lines may not be in the same column, such that the row data in the multiple lines appears scattered in that row. A table with span columns refers to a column spanning multiple regular columns, for example, a span column may span two regular columns or more. A table is intensive means that the locations of the cells are very close, and/or there are overlapping areas between rows and cells.

One or more embodiments are configured to address issues associated irregular tables. A method includes identifying a table block, identifying table headers, and identifying table rows. Identifying table rows may include selecting one or more anchor columns by using the column data in the anchor columns to help identifying rows and enlarging line spacings to help identifying rows. The method includes splitting the rows into small snippets, which may include training a machine learning model to extract row data from the small snippets (e.g., fixed form images) and then using the trained machine learning model to extract the row data. Further, the method includes combining the extracted row data as table data, thereby transforming the irregular table into a new data structure. In response to combining the extracted row data as table data in the new data structure, this may cause the data of the new data structure to be stored for access in a computer system, may cause the new data structure to be displayed on a computer system, may cause an artificial intelligence (AI) engine to output data of the new data structure in response to a request, may cause embedded features (e.g., feature vectors) to be created from the data in the new data structure to be utilized to train the AI engine, may cause the data of the new data structure to be accessible/utilized by a search engine 242, may cause the data to be provided to the Internet of Things (IoTs) to turn on/off an appliance or device, etc.

Descriptions of various embodiments of the present disclosure are presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

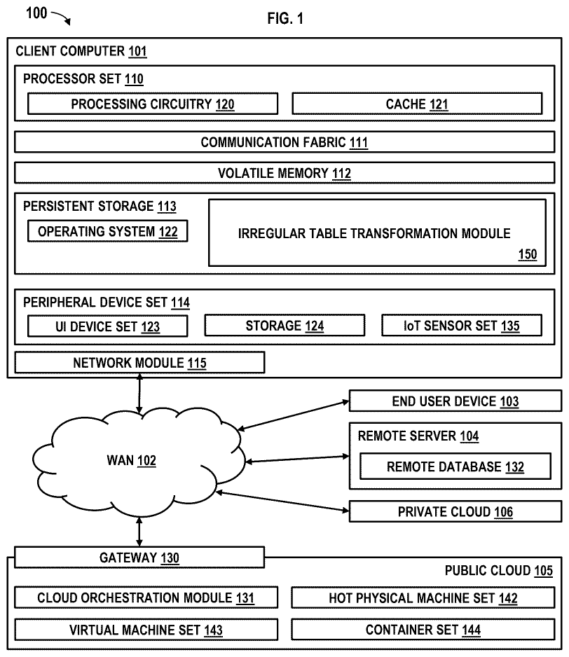

FIG. 1 illustrates a computing environment 100, according to an embodiment. Computing environment 100 contains an example of an environment for the execution of at least some of the computer code involved in performing the inventive methods, such as an irregular table transformation module 150 for parsing an irregular table, extracting the data, and generating a new format (or new table) for the extracted data. In addition to the irregular table transformation module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and irregular table transformation module 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in irregular table transformation module 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the irregular table transformation module 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to one or more embodiments, the computing environment 100 can provide for remote data storage. For example, the computer 101 can be a cloud storage system or other suitable system for storing data that is accessible to a user remotely, such as by accessing the computer 101 using the end user device 103. That is, a user can send a user operation (also referred to as a “user request”) from the end user device 103 to the computer 101 via the WAN 102. Although the user operation may appear to be simple, such as uploading an object to a cloud storage system, the complications of operating a cloud computing system often have side effects and produce ancillary data, which may be consumed by both the operator of the system (e.g., the computer 101) and by users or other components of the cloud architecture (e.g., the computing environment 100). Ancillary data may be created by user operations that trigger the creation of the ancillary data. Ancillary data may be resource consumption information, notification data, and/or the like, including combinations and/or multiples thereof. Data for an independent event may be inferred from another event (e.g., event to update resource consumption information for an entity in a system also means that the total consumption information for the oner of the entity is also updated).

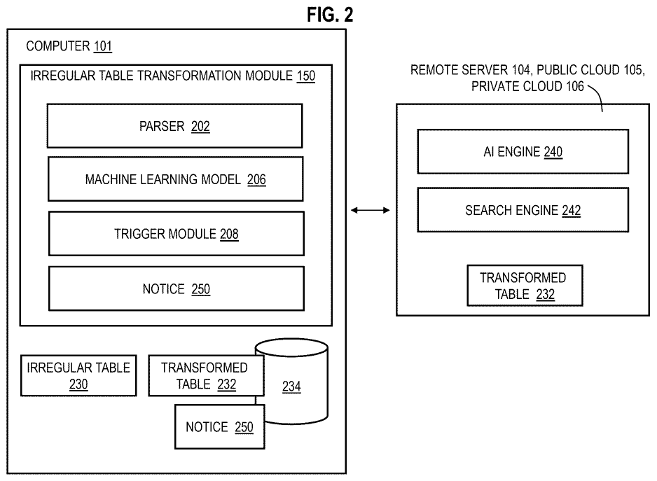

FIG. 2 depicts a block diagram of the computer 101 with further details for electronically parsing a complicated table to extract data, generating a new data structure for which to store and display the extracted data, and performing one or more actions using the extracted data in accordance with one or more embodiments. The irregular table transformation module 150 may include, call, employ, and/or be coupled to a parser 202, a machine learning model 206, and a trigger module 208. The irregular table transformation module 150 may include, call, employ, and/or be coupled to various application programming interfaces (APIs) to operate according to one or more embodiments.

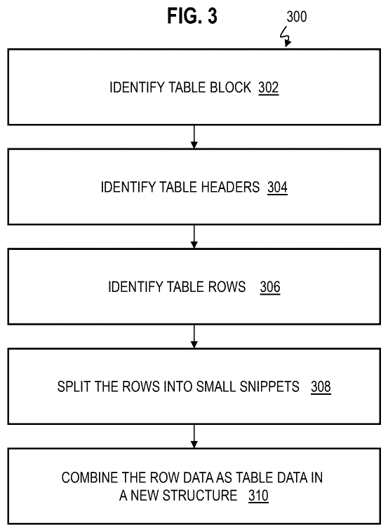

FIG. 3 depicts a flow diagram of a computer-implemented method 300 for electronically parsing a complicated table to extract data, generating a new data structure for which to store and display the extracted data, and performing one or more actions using the extracted data in accordance with one or more embodiments. In one or more embodiments, the computer-implemented method 300 can be performed by the irregular table transformation module 150 of the computer 101 in the computing environment 100 shown in FIG. 1.

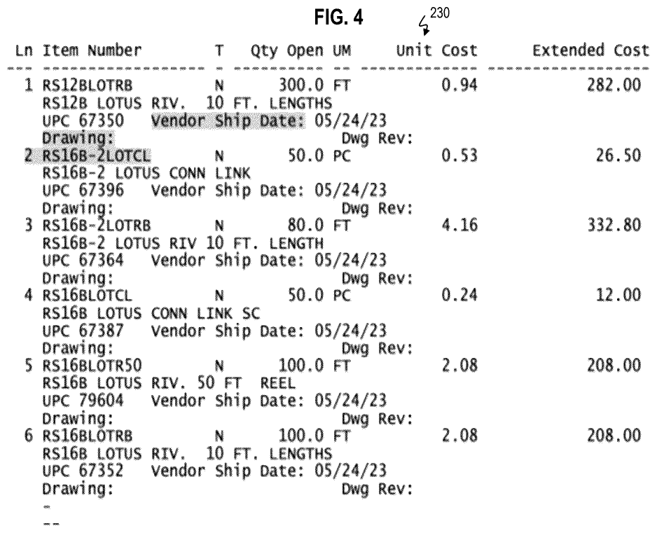

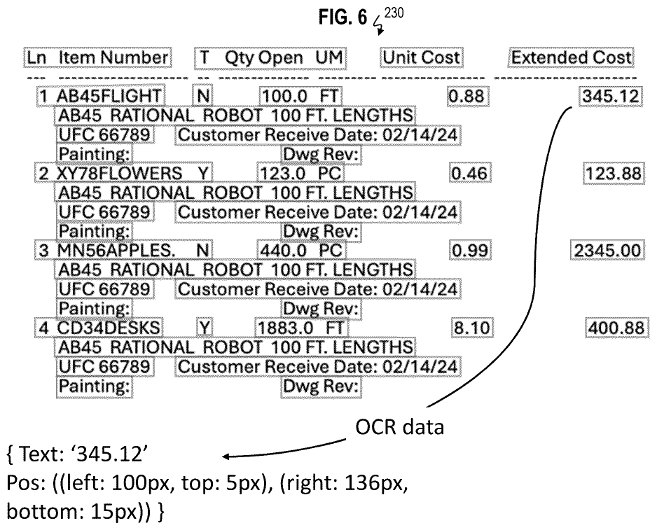

At block 302 of the computer-implemented method 300, the irregular table transformation module 150 is configured to identify a table block of unstructured data in an image. The irregular table transformation module 150 may call, employ, or be integrated with the parser 202, which can perform scanning, optical character recognition (OCR), and layout analysis. When scanning the image, the irregular table transformation module 150 is configured to perform OCR and layout analysis on the image to split the image into different table blocks. As such, the irregular table transformation module 150 is configured to determine whether each table block is text, a chart, a figure, or a table according to the text alignment and other known characteristics. In one or more embodiments, the irregular table 230 is part of an electronic or digital image that has be loaded or stored in the computer 101, and the irregular table 230 has been identified as the table block of unstructured data in the stored image. For explanation purposes, an example of the irregular table 230 is depicted in FIG. 4 in accordance with one or more embodiments. For explanation purposes, another example of the irregular table 230 is depicted in FIG. 6 in accordance with one or more embodiments. Although examples are shown for explanation purposes, it should be appreciated that there are many other ways of illustrating the irregular table 230 with unstructured data, and embodiments are not meant to be limited.

At block 304, the irregular table transformation module 150 is configured to identify table headers in the irregular table 230. This involves recognizing the headers of the irregular table to understand the structure and content of the columns. The irregular table transformation module 150 is configured to recognize that the headers are usually located at the top of the irregular table 230. For example, headers may be identified as the top row or upper most row, or headers may be identified as the top portion or upper most portion of text/data in the irregular table 230.

At block 306, the irregular table transformation module 150 is configured to identify table rows in the irregular table 230. The irregular table transformation module 150 is configured to scan the irregular table 230 to identify columns (e.g., identify candidate columns in the unstructured data) and analyze the column data. Analyzing the column data of the columns may include 1) determining if the column data is regular and 2) determining for columns (e.g., candidate columns) whether the column data type, column data location (e.g., coordinates), column data spacing, etc., is regular.

The irregular table transformation module 150 is configured to select one or more anchor columns wherein the column data is determined to be regular, for example, the column data type, column data location (e.g., coordinates), column data spacing, etc., is regular. The column data is regular refers to the column data in the selected anchor columns having equal distance or nearly equal distance between the column data, having the same or nearly the same column data type, and/or having locations in an applied grid (e.g., of x and y coordinates of a Cartesian graph) that are nearly equal distance apart from neighboring column data in the column. In many cases, the first column is standardized making it a suitable anchor column. Examples of the same column data type may include numeric data, people's names, telephone numbers, counties, cities, etc. In one or more embodiments, the irregular table transformation module 150 may employ a similarity algorithm or natural language processing (NLP) to determine in the column data is similar or the same type of column data. Once the anchor columns are found, the irregular table transformation module 150 is configured to use the column data in the anchor columns to help identify rows in the irregular table 230. Also, when identifying the rows, the irregular table transformation module 150 is configured to enlarge line spacings to better distinguish the neighboring rows from one another.

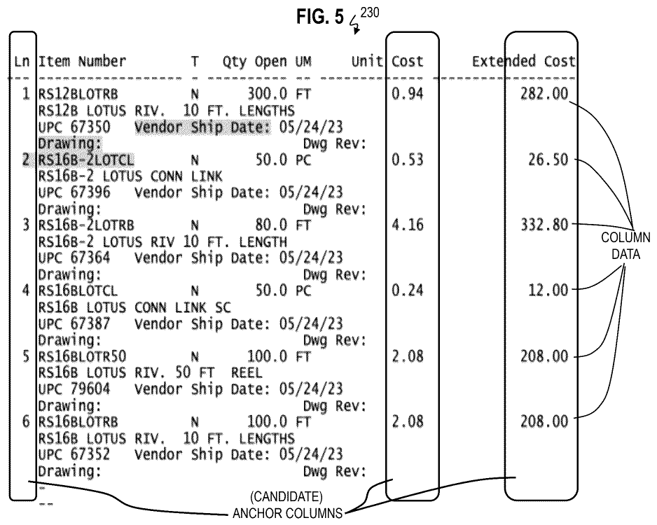

FIG. 5 depicts an example of selecting anchor columns in unstructured data of the irregular table 230. In FIG. 5, it can be seen that the Ln column, Unit cost column, and Extended cost column are selected as candidate anchor columns. Each of the candidate anchor columns has column data, which include anchor words.

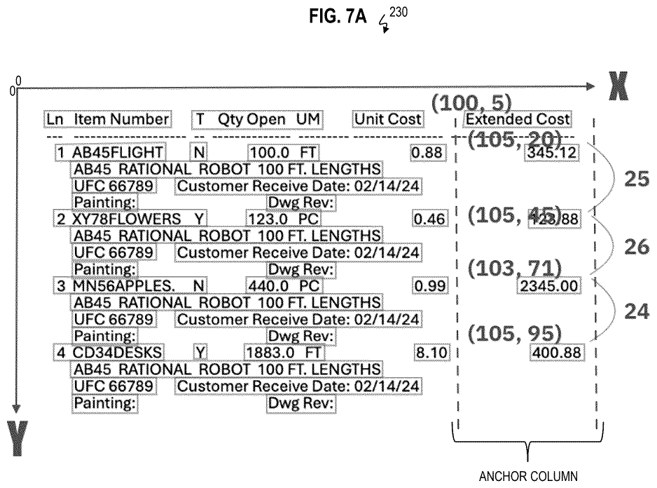

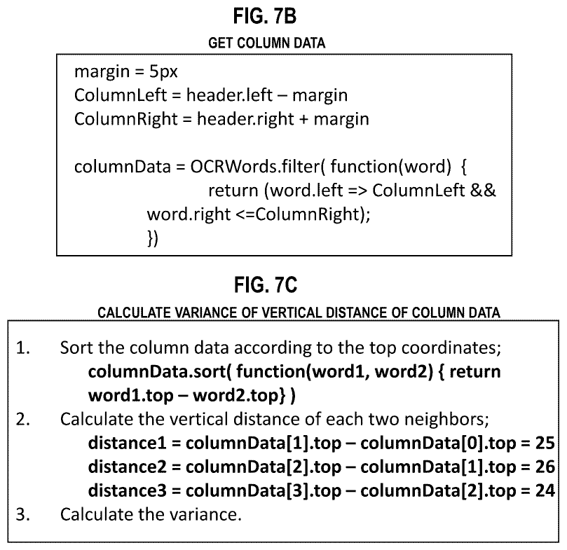

FIG. 7A depicts another example of selecting anchor columns in unstructured data of the irregular table 230. FIG. 7A illustrates details how x and y coordinates may be utilized to determine the beginning/start of column data in the example anchor column. Although the header may not be utilized to determine the anchor column, FIG. 7A shows that the header “Extended Cost” begins at the x and y coordinates (100, 5), the first anchor word of column data “345.12” begins at the x and y coordinates (105, 20), the second anchor word of column data “123.88” begins at the x and y coordinates (105, 450), the third anchor word of column data “2345.00” begins at the x and y coordinates (103, 71), and the fourth anchor word of column data “400.88” begins at the x and y coordinates (105,95). The vertical distance/spacing of neighboring anchor words of column data in the y-axis is nearly the same, for example, the vertical distance/spacing between anchor words is 25, 26, and 24 respectively from the first anchor word to the second anchor word to the third anchor word to the fourth anchor word.

FIG. 7B depicts example pseudocode for obtaining/getting the column data of a column. FIG. 7B illustrates how the left boundary and the right boundary of an anchor column may be found according to the column data vertically positioned in that column. In FIG. 7B, the example pseudocode is configured to get the column values according to the column header's location. The example pseudocode calculates the left and right border of the column header and then checks vertical spaces to get the column data that is inside the left and right borders. FIG. 7C depicts example pseudocode for calculating the variance of the vertical distances of the column data in an anchor column. Given the vertical distances (e.g., 25, 26, and 24) between anchor words of column data of the column depicted in FIG. 7A, a suitable software calculator may determine that the variance is 0.6667, the standard deviation is 0.8165, the mean is 25, and the count of numbers is 3.

Once the variance (or standard deviation) is found for each column, the irregular table transformation module 150 is configured to select the column with the minimal variance (or standard deviation) as the anchor column. The irregular table transformation module 150 may confirm that the variance is below a predefined threshold to be the anchor column. If there are multiple identical minimal variances, the irregular table transformation module 150 is configured to select the column with the maximum average vertical distance. If there is no variance that is below the predefined threshold, the irregular table transformation module 150 is configured to select the index column with “Ln”, “Index”, “Item No”, or “No” column headers. If there is no index column, the irregular table transformation module 150 is configured to traverse the OCR words to find the anchor words.

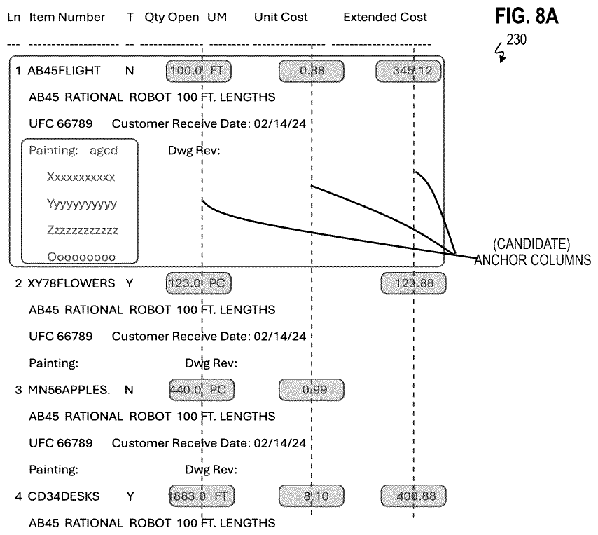

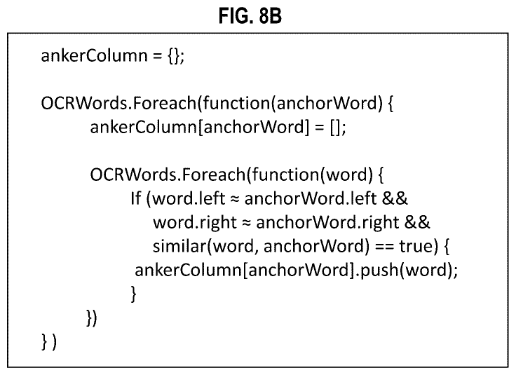

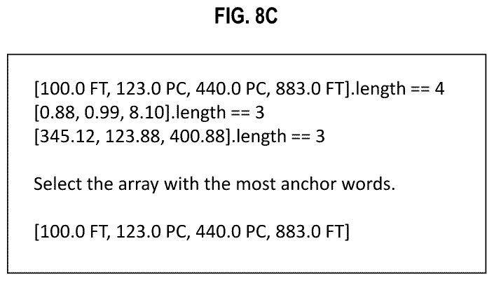

FIG. 8A depicts an example of selecting anchor columns in unstructured data of the irregular table 230. FIG. 8B depicts example pseudocode for finding anchor columns. FIG. 8C depicts example pseudocode for selecting an anchor column to use for subsequent operation among other anchor columns. For example, there are three candidate anchor columns in FIG. 8A. The example pseudocode first checks the 1st candidate anchor column staring at 100.0 FT; it checks the words in vertical direction with similar left and right border positions and similar types, and it gets: 123.0 PC, 140.0 PC, and 1883.0 FT. Next, the example pseudocode checks the 2nd candidate anchor column starting at 0.88, and it gets 0.99 and 8.10. Then, the example pseudocode checks the 3rd candidate anchor column starting at 345.12, and it gets 123.88 and 400.88. In FIG. 8C, the irregular table transformation module 150 is configured to select the anchor column that has the most anchor words (e.g., select an anchor column that has the most column data).

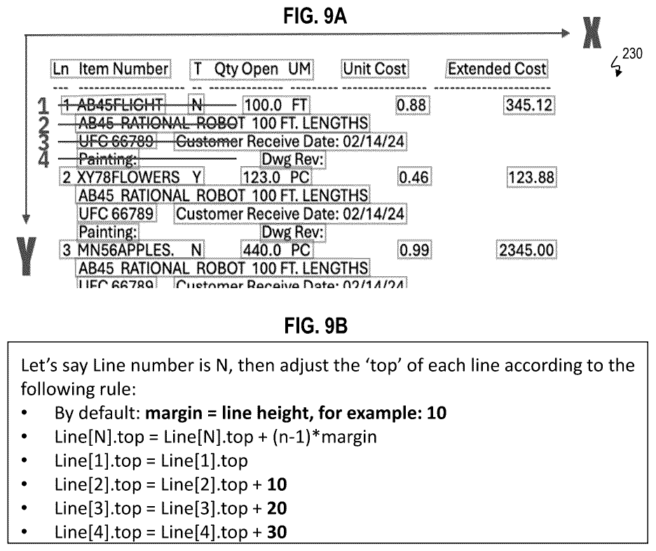

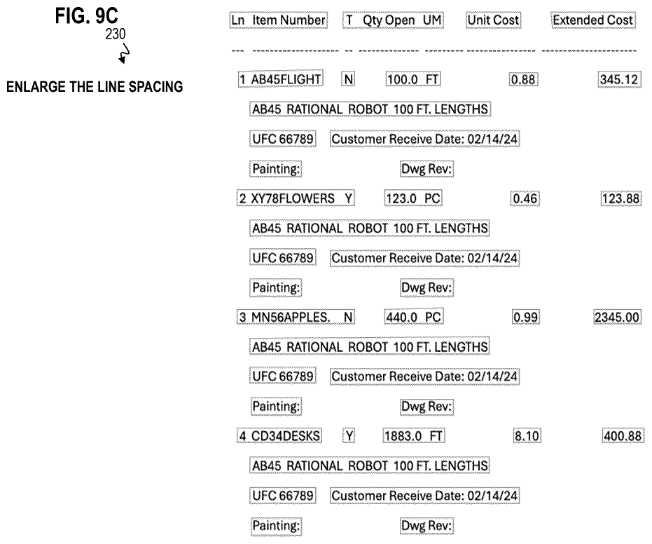

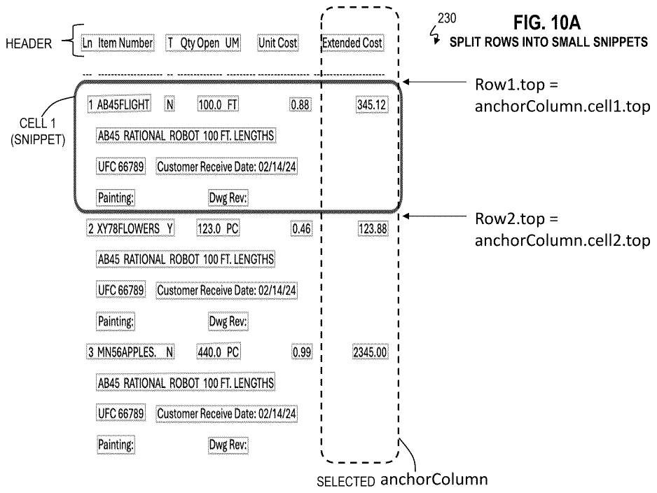

Further details of enlarging the line spacing of rows are depicted in FIGS. 9A, 9B, and 9C. FIG. 9A depicts the irregular table 230 in which an example row is being processed to find the top of each line within the that row such that the spacing can be increased between the lines in that row. In FIG. 9A, Lines [1], [2], [3], and [4] are identified. For illustration purposes, horizontal lines are depicted to respectively show the middle of Lines [1], [2], [3], and [4] and to point out that these are the four lines referred to in FIG. 9B. FIG. 9B depicts pseudocode for processing lines in each row to increase the spacing of the lines. FIG. 9C depicts the irregular table 230 after increasing/enlarging the line spacings of the rows and between neighboring rows. As noted herein, a single row may have multiple lines, and the increased spacing makes it easier for the irregular table transformation module 150 to identify one neighboring row from another neighboring row such that each row contains (only) one anchor word of column data in the anchor column.

Referring to FIG. 3, at block 308, the irregular table transformation module 150 is configured to split the rows into small snippets such that data can be extracted from each snippet. This corresponds to extracting data from each row. For example, the irregular table transformation module 150 is configured to divide the irregular table 230 into multiple snippets for easier processing.

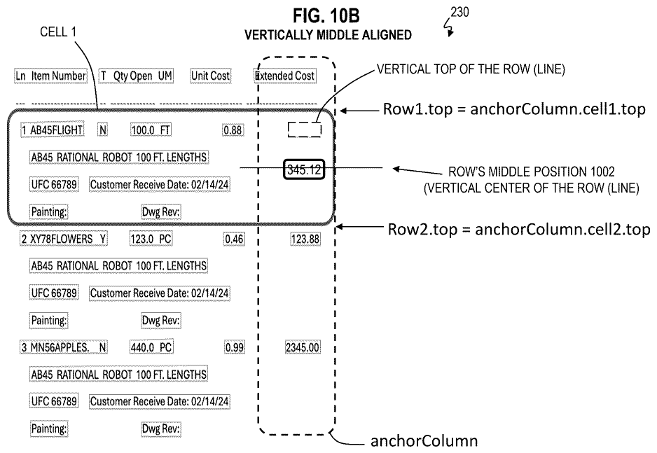

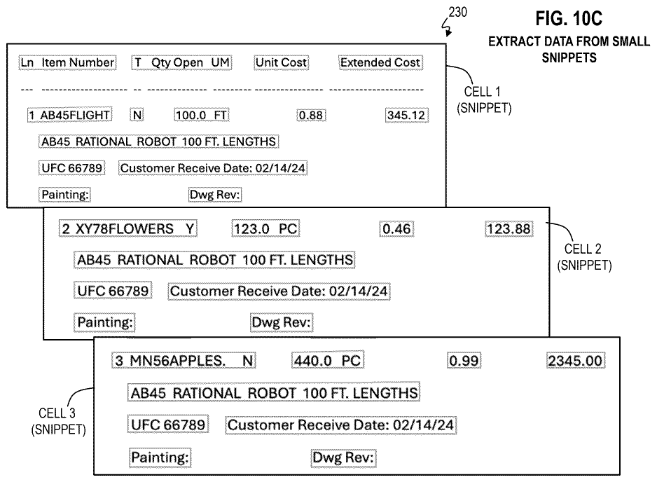

FIG. 10A depicts an example snippet as cell 1 in the irregular table 230, which is based on initially identifying the selected anchor column. For illustration purposes, the top of row 1 is identified and the top of row 2 is identified; this provides the boundary for the snippet or cell 1. Using the anchor column and the enlarged spacing, the irregular table transformation module 150 is configured to find the top of each row as a cell such that a snippet or cell is from, for example, the top of row 1 to the top of row 2 while including (only) one of the anchor words of the anchor column in the snippet or cell.

For example, the irregular table transformation module 150 can check the top cell's (e.g., cell 1) relative position to the header to determine the alignment. In other cases, cell 1 may be vertically middle aligned as depicted in FIG. 10B. In FIG. 10B, the irregular table transformation module 150 can calculate the row's middle position in this case, and then deduce the row height and separators between rows. FIG. 10B illustrates an example representing that the anchor word in the cell has been moved to the row's middle position 1002 (e.g., the middle of the row as opposed to the top of the row depicted in FIG. 10A). In FIG. 10B, the cell 1 is vertically middle aligned, and the irregular table transformation module 150 calculate the row's middle position 1002 in this case. This allows the irregular table transformation module 150 to deduce the row height and separators (e.g., separation) between rows. Each snippet is found similarly from the bottom of a neighboring cell. FIG. 10C depicts an example of the irregular table 230 with multiple snippets from which row data can be extracted.

Referring back to FIG. 3, at block 310, the irregular table transformation module 150 is configured to combine the extracted row data as table data into a new data structure. The irregular table transformation module 150 is configured to treat each row snippet as a fixed-form image, extracting the desired row data, and then combining the extracted row data to form a new data structure as, for example, a structured table. In one or more embodiments, the irregular table transformation module 150 is configured to generate a new data structure as a transformed table 232 that is structured with regular row and column spacing. In one or more embodiments, the irregular table transformation module 150 is configured to generate a new data structure as an electronically searchable database in a repository 234. In one or more embodiments, the irregular table transformation module 150 is configured to generate a new data structure as an array in the repository 234.

Upon the combination of the row data being formed into the new data structure, this acts as a trigger for a trigger module 208. In one or more embodiments, the trigger module 208 may periodically check the repository 234 for a new data structure such as a new database, an array, a new transformed table 232, etc. A notice 250 of the transformation of the irregular table 230 of an image into a new data structure is automatically generated and provided to the trigger module 208. In one or more embodiments, the irregular table transformation module 150 is configured push the notice 250 of the transformation from the irregular table 230 to the new data structure (e.g., a new database, an array, a new transformed table 232, etc.). In one or more embodiments, the trigger module 208 may pull the notice 250 of the transformation from the irregular table 230 to the new data structure (e.g., a new database, an array, a new transformed table 232, etc.). In one or more embodiments, an application programming interface (API) may be utilized to push or pull notices 250 for notification to the trigger module 208.

The trigger module 208 is configured to cause one or more actions to be executed in response to receiving the notice 250. In one or more embodiments, in response to the trigger of the combination of the row data being formed in the new data structure, the trigger module 208 may cause the data of the new data structure (e.g., a new database, an array, a new transformed table 232, etc.) to be stored for access in the remote server 140, the public cloud 105, and/or the private cloud 106, may cause the new data structure to be displayed, may cause an AI engine 240 to be trained, may cause (embedded) features to be created (as vectors) from the accessible data in the new data structure to be utilized to train the AI engine, may cause the data of the new data structure (e.g., a new database, an array, a new transformed table 232, etc.) to be accessible/utilized by a search engine 242, may cause the IoTs to turn on/off an appliance or device, etc.

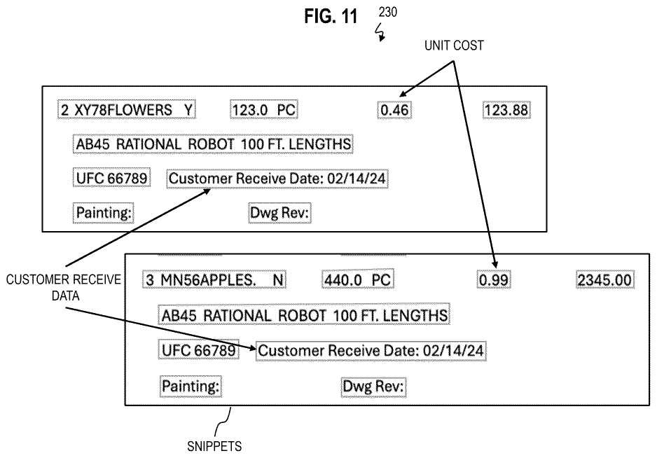

FIG. 11 depicts an example of extracting data from each of the snippets or rows as fixed from images. In one or more embodiments, the irregular table transformation module 150 may employ or call the parser 202 and/or the machine learning model 206 to extract the row data from the snippet. The machine learning model 206 can receive each snippet, which is a fixed form image, as input and output text of the snippet as row data. The machine learning model 206 can be trained on historical data of various types of snippets to learn how to extract data to be added into the new data structure.

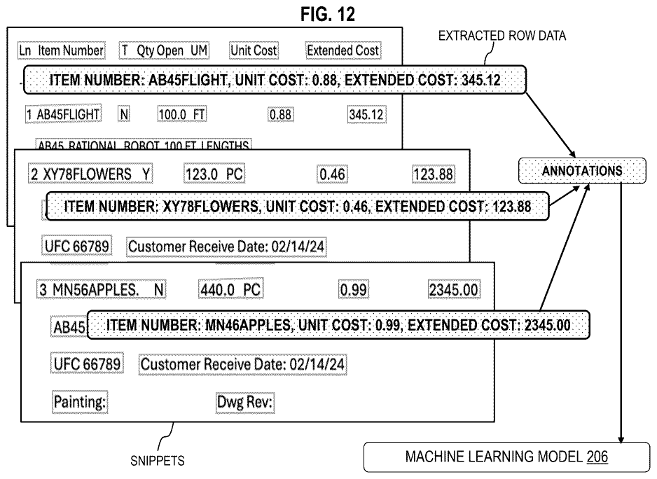

FIG. 12 depicts an example of training/inferring the machine learning model 206 to extract row data from various snippets. FIG. 12 illustrates three different snippets as input and a portion of row data is extracted with corresponding headers by the machine learning model 206 as output. The machine learning model 206 continues processing to extract all of the row data from each snippet.

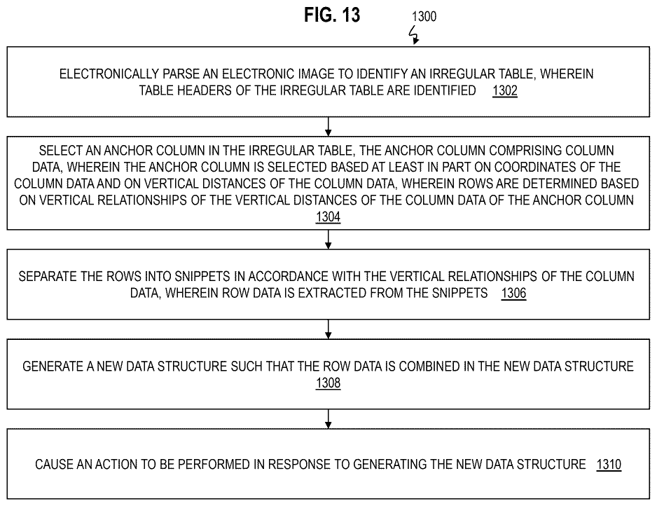

FIG. 13 depicts a flowchart of a computer-implemented method 1300 for electronically parsing a complicated table to extract data, generating a new data structure for which to store and display the extracted data, and performing one or more actions using the extracted data according to one or more embodiments. Reference can be made to any figures discussed herein.

At block 1302, the irregular table transformation module 150 is configured to electronically parse an electronic image to identify an irregular table 230, where table headers of the irregular table 230 are identified. At block 1304, the irregular table transformation module 150 is configured to selecting an anchor column in the irregular table 230, the anchor column comprising column data, where the anchor column is selected based at least in part on coordinates of the column data and on vertical distances of the column data, where rows are determined based on vertical relationships of the vertical distances (e.g., vertical spacing) of the column data of the anchor column. At block 1306, the irregular table transformation module 150 is configured to separate the rows into snippets in accordance with the vertical relationships of the column data, where row data is extracted from the snippets. Examples of snippets as fixed form images are depicted in FIGS. 10A, 10B, 11, 12. At block 1308, the irregular table transformation module 150 is configured to generate a new data structure (e.g., a database, a transformed table 232, etc.) such that the row data is combined in the new data structure. At block 1310, the irregular table transformation module 150 is configured to cause an action to be performed in response to generating the new data structure (e.g., in response to a notice 250).

According to one or more embodiments, the irregular table includes unstructured data as the row data. The anchor column is selected from a plurality of candidate anchor columns. FIGS. 5 and 8A depict a plurality of candidate anchor columns. The anchor column is selected from a plurality of candidate anchor columns based at least in part on the anchor column having a smaller variance for the vertical distances (e.g., the variance or standard deviation of the vertical distances of the column data is smaller) than a variance of other vertical distances for the plurality of candidate anchor columns. The anchor column is selected from a plurality of candidate anchor columns based at least in part on the anchor column having a greater number of the column data (e.g., the most anchor words) than a number of other column data for the plurality of candidate anchor columns.

Further, the separating the rows into the snippets in accordance with the vertical relationships of the vertical distances of the column data includes: enlarging line spacings in the rows and selecting each of the snippets to include a single one of the column data of the anchor column.

Also, generating the new data structure acts as a trigger to perform the action, and the action includes at least one of storing the new data structure to be accessible by a computer system (e.g., the remote server 104, public cloud 105, private cloud 106, end user device 103, etc.), causing the new data structure (e.g., a database, a transformed table 232, etc.) to be displayed, causing an artificial intelligence engine 240 to be trained with (embedded) features generated from the new data structure, or causing the new data structure to be utilized by a search engine 242.

One or more embodiments of the present disclosure improve the functioning of a computer by enhancing its ability to accurately and efficiently parse and extract data from complicated or irregular tables in electronic images. Traditional methods struggle with unstructured tables that lack clear boundaries, have multi-line rows, span columns, or are intensive. Technical effects and solutions include identifying table blocks using advanced scanning, optical character recognition (OCR), and layout analysis techniques to identify table blocks within an image. This allows the computer to distinguish between different types of content (text, charts, figures, tables) and focus on the relevant table data. As technical effects and solutions, one or more embodiments enhance the computer's ability to process and understand complex table data, leading to improved data extraction accuracy, reduced processing time (e.g., using fewer CPUs), and better utilization of extracted information. This results in more efficient data analysis, improved decision-making, and enhanced performance of applications that rely on table data.

Technical effects and solutions include identifying table headers and rows because by recognizing table headers and analyzing column data, the computer can understand the structure and content of the irregular table. This involves selecting anchor columns based on the regularity of column data, such as coordinates and vertical distances, which helps in accurately identifying rows.

Technical effects and solutions improve row identification by enlarging line spacings, making it easier for the computer to distinguish between rows. This reduces errors in data extraction caused by closely spaced or overlapping rows. By splitting rows into snippets which includes dividing the table into small snippets, the computer can process each row individually. This modular approach simplifies data extraction and reduces the complexity of handling large, unstructured tables.

Technical effects and solutions include extracting row data from snippets using machine learning, and the machine learning model is trained on historical data of snippets from numerous irregular tables to recognize patterns and accurately extract relevant information from fixed-form images. This enhances the computer's ability to handle diverse and complex table formats.

Technical effects and solutions include generating a new data structure, in which the extracted row data is combined into a new, structured format, such as a database or a transformed table. Now, this structured data can be easily accessed, stored, displayed, and/or used for further processing by other computer systems or applications.

Technical effects and solutions include triggering actions based on extracted data, where a trigger module can initiate actions based on the newly generated data structure. These actions can include storing the data for future access, displaying it, training artificial intelligence (AI) engines, and/or making the data accessible to search engines.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
electronically parsing an electronic image to identify an irregular table, wherein table headers of the irregular table are identified;
selecting an anchor column in the irregular table, the anchor column comprising column data, wherein the anchor column is selected based at least in part on coordinates of the column data and on vertical distances of the column data, wherein rows are determined based on vertical relationships of the vertical distances of the column data of the anchor column;
separating the rows into snippets in accordance with the vertical relationships of the column data, wherein row data is extracted from the snippets;
generating a new data structure such that the row data is combined in the new data structure; and
causing an action to be performed in response to generating the new data structure.

2. The computer-implemented method of claim 1, wherein the irregular table comprises unstructured data as the row data.

3. The computer-implemented method of claim 1, wherein the anchor column is selected from a plurality of candidate anchor columns.

4. The computer-implemented method of claim 1, wherein the anchor column is selected from a plurality of candidate anchor columns based at least in part on the anchor column having a smaller variance for the vertical distances than a variance of other vertical distances for the plurality of candidate anchor columns.

5. The computer-implemented method of claim 1, wherein the anchor column is selected from a plurality of candidate anchor columns based at least in part on the anchor column having a greater number of the column data than a number of other column data for the plurality of candidate anchor columns.

6. The computer-implemented method of claim 1, wherein the separating the rows into the snippets in accordance with the vertical relationships of the vertical distances of the column data comprises: enlarging line spacings in the rows and selecting each of the snippets to include a single one of the column data of the anchor column.

7. The computer-implemented method of claim 1, wherein:
the generating of the new data structure acts as a trigger to perform the action; and
the action comprises at least one of storing the new data structure to be accessible by a computer system, causing the new data structure to be displayed, causing an artificial intelligence engine to be trained with features generated from the new data structure, or causing the new data structure to be utilized by a search engine.

8. A system comprising:
a memory comprising computer readable instructions; and
a processing device for executing the computer readable instructions, the computer readable instructions controlling the processing device to perform operations comprising:
electronically parsing an electronic image to identify an irregular table, wherein table headers of the irregular table are identified;
selecting an anchor column in the irregular table, the anchor column comprising column data, wherein the anchor column is selected based at least in part on coordinates of the column data and on vertical distances of the column data, wherein rows are determined based on vertical relationships of the vertical distances of the column data of the anchor column;
separating the rows into snippets in accordance with the vertical relationships of the column data, wherein row data is extracted from the snippets;
generating a new data structure such that the row data is combined in the new data structure; and
causing an action to be performed in response to generating the new data structure.

9. The system of claim 8, wherein the irregular table comprises unstructured data as the row data.

10. The system of claim 8, wherein the anchor column is selected from a plurality of candidate anchor columns.

11. The system of claim 8, wherein the anchor column is selected from a plurality of candidate anchor columns based at least in part on the anchor column having a smaller variance for the vertical distances than a variance of other vertical distances for the plurality of candidate anchor columns.

12. The system of claim 8, wherein the anchor column is selected from a plurality of candidate anchor columns based at least in part on the anchor column having a greater number of the column data than a number of other column data for the plurality of candidate anchor columns.

13. The system of claim 8, wherein the separating the rows into the snippets in accordance with the vertical relationships of the vertical distances of the column data comprises: enlarging line spacings in the rows and selecting each of the snippets to include a single one of the column data of the anchor column.

14. The system of claim 8, wherein:
the generating of the new data structure acts as a trigger to perform the action; and
the action comprises at least one of storing the new data structure to be accessible by a computer system, causing the new data structure to be displayed, causing an artificial intelligence engine to be trained with features generated from the new data structure, or causing the new data structure to be utilized by a search engine.

15. A computer program product comprising:
a set of one or more computer-readable storage media;
program instructions, collectively stored in the set of one or more storage media, for causing a processor set to perform computer operations:
electronically parsing an electronic image to identify an irregular table, wherein table headers of the irregular table are identified;
selecting an anchor column in the irregular table, the anchor column comprising column data, wherein the anchor column is selected based at least in part on coordinates of the column data and on vertical distances of the column data, wherein rows are determined based on vertical relationships of the vertical distances of the column data of the anchor column;
separating the rows into snippets in accordance with the vertical relationships of the column data, wherein row data is extracted from the snippets;
generating a new data structure such that the row data is combined in the new data structure; and
causing an action to be performed in response to generating the new data structure.

16. The computer program product of claim 15, wherein the irregular table comprises unstructured data as the row data.

17. The computer program product of claim 15, wherein the anchor column is selected from a plurality of candidate anchor columns.

18. The computer program product of claim 15, wherein the anchor column is selected from a plurality of candidate anchor columns based at least in part on the anchor column having a smaller variance for the vertical distances than a variance of other vertical distances for the plurality of candidate anchor columns.

19. The computer program product of claim 15, wherein the anchor column is selected from a plurality of candidate anchor columns based at least in part on the anchor column having a greater number of the column data than a number of other column data for the plurality of candidate anchor columns.

20. The computer program product of claim 15, wherein the separating the rows into the snippets in accordance with the vertical relationships of the vertical distances of the column data comprises: enlarging line spacings in the rows and selecting each of the snippets to include a single one of the column data of the anchor column.
